(19) United States
(12) Patent Application Publication
(10) Pub. No.: US 2019/0375928 A1
(43) Pub. Date: Dec. 12, 2019

(54) THERMOPLASTIC RESIN COMPOSITION, INNER LINER, AND PNEUMATIC TIRE

(71) Applicant: The Yokohama Rubber Co., Ltd., Tokyo (JP)

(72) Inventor: Shun SATO, Hiratsuka-shi, Kanagawa (JP)

(21) Appl. No.: 16/480,349

(22) PCT Filed: Jan. 19, 2018
(86) PCT No.: PCT/JP2018/001659

§ 371 Date: Jul. 24, 2019

(30) Foreign Application Priority Data
Feb. 1, 2017 (JP) 2017-016949

(51) Int. Cl. C08L 23/28; C08L 53/02; C08L 29/06; B60C 1/00

(52) U.S. Cl. CPC C08L 23/283; C08L 53/025; C08L 29/06; C08L 2205/035; C08L 2207/02; C08L 2205/03; B60C 1/0008

(57) ABSTRACT

Provided is a thermoplastic resin composition from which an inner liner for pneumatic tires that decreases little in gas-barrier property upon fatigue can be produced. The thermoplastic resin composition comprises a matrix phase, which comprises an ethylene/vinyl alcohol copolymer (A), and a dispersed phase, which comprises a brominated isobutylene/p-methylstyrene copolymer (B) and an acid-modified styrene/ethylene/butylene/styrene copolymer (C), and is characterized by satisfying 0.02≤(W_{B}×B_{B})×(W_{C}×S_{C})/(W_{A}×V_{A})≤0.85 where W_{A}, W_{B}, and W_{C} are the weight proportions of the components (A), (B), and (C), respectively, to the total weight of the polymer components contained in the thermoplastic resin composition, V_{A} (wt %) is the vinyl alcohol content in the component (A), B_{B} (wt %) is the p-bromomethylstyrene content in the component (B), and S_{C} (wt %) is the styrene content in the component (C).

### FIELD

The present invention relates to a thermoplastic resin composition; an inner liner for a pneumatic tire, which is composed of the thermoplastic resin composition; and a pneumatic tire comprising the inner liner. More particularly, the present invention relates to a thermoplastic resin composition composed of a matrix phase that comprises an ethylene-vinyl alcohol copolymer and a dispersed phase that comprises a brominated isobutylene-p-methylstyrene copolymer; an inner liner for a pneumatic tire, which comprises of the thermoplastic resin composition; and a pneumatic tire comprising the inner liner.

### BACKGROUND

There is known a thermoplastic elastomer composition in which a rubber composition containing a halogenated isoolefin-p-alkylstyrene copolymer is dispersed in a thermoplastic resin composition that contains a polyamide and an ethylene-vinyl alcohol copolymer or a polyvinyl alcohol, and the rubber composition is crosslinked (Japanese Unexamined Patent Publication (Kokai) No. 2012-46614).

Further, a thermoplastic elastomer composition which includes a polymer component that contains a halogenated isoolefin-p-alkylstyrene copolymer, an acid anhydride group-containing modified rubber and an ethylene-vinyl alcohol copolymer, along with a processing aid composed of an alkaline earth metal salt of a higher fatty acid and a crosslinking agent, is known (WO 2015/147148 A1).

### CITATION LIST

### Patent Literature

[PTL 1] Japanese Unexamined Patent Publication (Kokai) No. 2012-46614

[PTL 2] WO 2015/147148 A1

### SUMMARY

### Technical Problem

However, these thermoplastic elastomer compositions disclosed in Japanese Unexamined Patent Publication (Kokai) No. 2012-46614 and WO 2015/147148 A1 are observed with deterioration of the gas-barrier properties caused by fatigue when used as an inner liner of a pneumatic tire.

An object of the present invention is to provide a thermoplastic resin composition comprising a matrix phase that comprises an ethylene-vinyl alcohol copolymer and a dispersed phase that comprises a brominated isobutylene-p-methylstyrene copolymer, which thermoplastic resin composition is capable of yielding, when used as a material of a tire inner liner, an inner liner that hardly exhibits deterioration of the gas-barrier properties caused by fatigue.

### Solution to Problem

The present inventor discovered that deterioration of the gas-barrier properties caused by fatigue can be efficiently suppressed by incorporating an acid-modified styrene-ethylene-butylene-styrene copolymer into a thermoplastic resin composition composed of a matrix phase comprising an ethylene-vinyl alcohol copolymer and a dispersed phase comprising a brominated isobutylene-p-methylstyrene copolymer, thereby completing the present invention.

The present invention provides a thermoplastic resin composition comprising a matrix phase that comprises an ethylene-vinyl alcohol copolymer (A), and a dispersed phase that comprises a brominated isobutylene-p-methylstyrene copolymer (B) and an acid-modified styrene-ethylene-butylene-styrene copolymer (C), wherein the thermoplastic resin composition satisfies the following formula:

0.02≤(W_{B}×B_{B})×(W_{C}×S_{C})/(W_{A}×V_{A})≤0.85,

wherein

W_{A} represents a weight ratio of the ethylene-vinyl alcohol copolymer (A) to a total weight of polymer components in the thermoplastic resin composition,

W_{B} represents a weight ratio of the brominated isobutylene-p-methylstyrene copolymer (B) to a total weight of polymer components in the thermoplastic resin composition,

W_{C} represents a weight ratio of the acid-modified styrene-ethylene-butylene-styrene copolymer (C) to a total weight of polymer components in the thermoplastic resin composition,

V_{A} represents a vinyl alcohol content (% by weight) in the ethylene-vinyl alcohol copolymer (A),

B_{B} represents a p-bromomethylstyrene content (% by weight) in the brominated isobutylene-p-methylstyrene copolymer (B), and

S_{C} represents a styrene content (% by weight) in the acid-modified styrene-ethylene-butylene-styrene copolymer (C).

The present invention includes the following aspects.

[1] A thermoplastic resin composition comprising a matrix phase that comprises an ethylene-vinyl alcohol copolymer (A), and a dispersed phase that comprises a brominated isobutylene-p-methylstyrene copolymer (B) and an acid-modified styrene-ethylene-butylene-styrene copolymer (C), wherein the thermoplastic resin composition satisfies the following formula:

0.02≤(W_{B}×B_{B})×(W_{C}×S_{C})/(W_{A}×V_{A})≤0.85

wherein

W_{A} represents a weight ratio of the ethylene-vinyl alcohol copolymer (A) to a total weight of polymer components in the thermoplastic resin composition,

W_{B} represents a weight ratio of the brominated isobutylene-p-methylstyrene copolymer (B) to a total weight of polymer components in the thermoplastic resin composition,

W_{C} represents a weight ratio of the acid-modified styrene-ethylene-butylene-styrene copolymer (C) to a total weight of polymer components in the thermoplastic resin composition,

V_{A} represents a vinyl alcohol content (% by weight) in the ethylene-vinyl alcohol copolymer (A),

B_{B} represents a p-bromomethylstyrene content (% by weight) in the brominated isobutylene-p-methylstyrene copolymer (B), and

S_{C} represents a styrene content (% by weight) in the acid-modified styrene-ethylene-butylene-styrene copolymer (C).

[2] The thermoplastic resin composition according to [1], wherein the acid-modified styrene-ethylene-butylene-styrene copolymer (C) has an acid value of 0.5 to 30 mg-CH₃ONa/g.

[3] The thermoplastic resin composition according to [1] or [2], wherein a weight ratio (B)/(C) of the brominated isobutylene-p-methylstyrene copolymer (B) and the acid-modified styrene-ethylene-butylene-styrene copolymer (C) is 60/40 to 10/90.

[4] The thermoplastic resin composition according to any one of [1] to [3], comprising 20 to 300 parts by weight of the ethylene-vinyl alcohol copolymer (A) based on 100 parts by weight of elastomer components in the dispersed phase.

[5] The thermoplastic resin composition according to any one of [1] to [4], wherein the vinyl alcohol content V_{A} (% by weight) in the ethylene-vinyl alcohol copolymer (A) is 50 to 90.

[6] The thermoplastic resin composition according to any one of [1] to [5], wherein the p-bromomethylstyrene content B_{B} (% by weight) in the brominated isobutylene-p-methylstyrene copolymer (B) is 1.0 to 5.0.

[7] The thermoplastic resin composition according to any one of [1] to [6], wherein the styrene content S_{C} (% by weight) in the acid-modified styrene-ethylene-butylene-styrene copolymer (C) is 5 to 40.

[8] The thermoplastic resin composition according to any one of [1] to [7], further comprising a metallic soap (D).

[9] An inner liner for a pneumatic tire, comprising the thermoplastic resin composition according to any one of [1] to [8].

[10] A pneumatic tire comprising the inner liner according to [9].

### Advantageous Effects of Invention

The thermoplastic resin composition of the present invention can yield an inner liner that hardly exhibits deterioration of the gas-barrier properties caused by fatigue.

### DESCRIPTION OF EMBODIMENTS

The present invention provides a thermoplastic resin composition comprising a matrix phase that comprises an ethylene-vinyl alcohol copolymer (A), and a dispersed phase that comprises a brominated isobutylene-p-methylstyrene copolymer (B) and an acid-modified styrene-ethylene-butylene-styrene copolymer (C), and the thermoplastic resin composition satisfies the following formula:

0.02≤(W_{B}×B_{B})×(W_{C}×S_{C})/(W_{A}×V_{A})≤0.85

wherein

W_{A} represents a weight ratio of the ethylene-vinyl alcohol copolymer (A) to a total weight of polymer components in the thermoplastic resin composition,

W_{B} represents a weight ratio of the brominated isobutylene-p-methylstyrene copolymer (B) to a total weight of polymer components in the thermoplastic resin composition,

W_{C} represents a weight ratio of the acid-modified styrene-ethylene-butylene-styrene copolymer (C) to a total weight of polymer components in the thermoplastic resin composition,

V_{A} represents a vinyl alcohol content (% by weight) in the ethylene-vinyl alcohol copolymer (A),

B_{B} represents a p-bromomethylstyrene content (% by weight) in the brominated isobutylene-p-methylstyrene copolymer (B), and

S_{C} represents a styrene content (% by weight) in the acid-modified styrene-ethylene-butylene-styrene copolymer (C).

The term “polymer components in the thermoplastic resin composition” used herein refers to at least the ethylene-vinyl alcohol copolymer (A), the brominated isobutylene-p-methylstyrene copolymer (B) and the acid-modified styrene-ethylene-butylene-styrene copolymer (C) and, when the thermoplastic resin composition comprises other resin(s) (e.g., a polyamide) and/or an elastomer(s) (e.g., a halogenated butyl rubber, an ethylene-propylene rubber, and an acid-modified EB), the term also encompasses such resin(s) and elastomer(s).

The ethylene-vinyl alcohol copolymer (A) contains ethylene units and vinyl alcohol units as repeating structural units, and the term “vinyl alcohol content (% by weight)” used herein refers to the number of grams of the vinyl alcohol units contained in 100 g of the ethylene-vinyl alcohol copolymer.

The brominated isobutylene-p-methylstyrene copolymer (B) contains isobutylene units, p-methylstyrene units and p-bromomethylstyrene units as repeating structural units, and the term “p-bromomethylstyrene content (% by weight)” used herein refers to the number of grams of the p-bromomethylstyrene units contained in 100 g of the brominated isobutylene-p-methylstyrene copolymer.

The acid-modified styrene-ethylene-butylene-styrene copolymer (C) contains styrene units, ethylene units and butylene units as repeating structural units, and the term “styrene content (% by weight)” used herein refers to the number of grams of the styrene units contained in 100 g of the acid-modified styrene-ethylene-butylene-styrene copolymer.

In the thermoplastic resin composition comprising a matrix phase that comprises the ethylene-vinyl alcohol copolymer (A) and a dispersed phase that comprises the brominated isobutylene-p-methylstyrene copolymer (B), by incorporating the acid-modified styrene-ethylene-butylene-styrene copolymer (C) and setting the relationship of the copolymerization ratios and the contents of these components to be in a specific range, deterioration of the gas-barrier properties of the thermoplastic resin composition caused by fatigue can be efficiently suppressed.

The value of (W_{B}×B_{B})×(W_{C}×S_{C})/(W_{A}×V_{A}) is 0.02 to 0.85, preferably 0.05 to 0.75, more preferably 0.1 to 0.65. When the value of (W_{B}×B_{B})×(W_{C}×S_{C})/(W_{A}×V_{A}) is excessively small, the effect of suppressing the deterioration of the gas-barrier properties caused by fatigue may not be sufficiently attained, whereas when the value of (W_{B}×B_{B})×(W_{C}×S_{C})/(W_{A}×V_{A}) is excessively large, the film-forming properties may be deteriorated.

The thermoplastic resin composition of the present invention comprises a matrix phase and a dispersed phase. In other words, the thermoplastic resin composition of the present invention has a so-called sea-island structure. The matrix phase comprises the ethylene-vinyl alcohol copolymer (A). The dispersed phase comprises the brominated isobutylene-p-methylstyrene copolymer (B) and the acid-modified styrene-ethylene-butylene-styrene copolymer (C).

The ethylene-vinyl alcohol copolymer (hereinafter, also referred to as “EVOH”) used in the present invention is a copolymer composed of an ethylene unit (—CH₂CH₂—) and a vinyl alcohol unit (—CH₂—CH(OH)—), and may also contain other structural unit(s) in addition to the ethylene unit and the vinyl alcohol unit within a range that does not adversely affect the effects of the present invention. The vinyl alcohol content V_{A} in the ethylene-vinyl alcohol copolymer is not limited as long as the above-described relational formula is satisfied; however, it is preferably 50 to 90% by weight, more preferably 55 to 87% by weight, still more preferably 60 to 85% by weight. An excessively low vinyl alcohol content V_{A} may lead to poor pre-fatigue gas-barrier properties, whereas an excessively high vinyl alcohol content V_{A} may lead to insufficient bending fatigue resistance at low temperatures. The ethylene-vinyl alcohol copolymer is a saponification product of an ethylene-vinyl acetate copolymer, and the saponification degree thereof is preferably 90% or higher, more preferably 98% or higher. An excessively low saponification degree of the ethylene-vinyl alcohol copolymer leads to reduced gas-barrier properties and reduced thermal stability. Ethylene-vinyl alcohol copolymers are commercially available and can be obtained under the trade names of, for example, SOARNOL® from The Nippon Synthetic Chemical Industry Co., Ltd. and EVAL® from Kuraray Co., Ltd. Specific examples of commercially available ethylene-vinyl alcohol copolymer products include SOARNOL® H4815B (vinyl alcohol content V_{A}: 63% by weight), E3808 (vinyl alcohol content V_{A}: 72% by weight) and V2504 (vinyl alcohol content V_{A}: 83% by weight), which are manufactured by The Nippon Synthetic Chemical Industry Co., Ltd.

The brominated isobutylene-p-methylstyrene copolymer (B) used in the present invention can be produced by brominating a copolymer of isobutylene and p-methylstyrene, and the mixing ratio of isobutylene and p-methylstyrene, the polymerization ratio, the average molecular weight, the polymerization mode (e.g., a block copolymer or a random copolymer), the viscosity, the bromination rate and the like are not particularly limited and can be arbitrarily selected in accordance with the physical properties and the like that are demanded for the thermoplastic elastomer composition.

The brominated isobutylene-p-methylstyrene copolymer is obtained by bromination of an isobutylene-p-methylstyrene copolymer having a repeating unit represented by the following chemical formula (1):

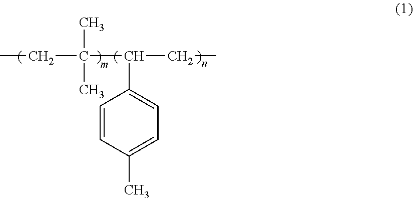

Typically, the brominated isobutylene-p-methylstyrene copolymer has a repeating structural unit represented by the following chemical formula (2):

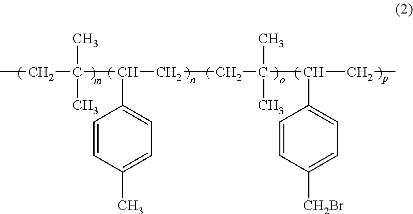

Such a brominated isobutylene-p-methylstyrene copolymer is available under the trade name of EXXPRO® from ExxonMobil Chemical Company, Inc.

The p-bromomethylstyrene content B_{B} in the brominated isobutylene-p-methylstyrene copolymer (B) is not limited as long as the above-described relational formula is satisfied; however, it is preferably 1.0 to 5.0% by weight, more preferably 1.1 to 4.5% by weight, still more preferably 1.2 to 4.0% by weight. When the p-bromomethylstyrene content B_{B} is excessively low, the brominated isobutylene-p-methylstyrene copolymer (B) is not finely dispersed in the ethylene-vinyl alcohol copolymer, and its modification effect as a rubber may thus be insufficient, whereas when the p-bromomethylstyrene content B_{B} is excessively high, the fluidity is insufficient due to enhanced interaction with the vinyl alcohol of the ethylene-vinyl alcohol copolymer, and this may lead to deterioration of the film-forming properties.

It is preferable that the brominated isobutylene-p-methylstyrene copolymer be dynamically cross-linked with a crosslinking agent. By dynamically crosslinking the brominated isobutylene-p-methylstyrene copolymer, the matrix phase and the dispersed phase of the thermoplastic resin composition can be fixed. The dynamic crosslinking can be performed by melt-kneading the brominated isobutylene-p-methylstyrene copolymer together with the crosslinking agent.

Examples of the crosslinking agent used in the dynamic crosslinking include zinc white, stearic acid, zinc stearate, magnesium oxide, m-phenylene bismaleimide, alkyl phenol resins and halides thereof, and secondary amines. Examples of the secondary amines that can be used as the crosslinking agent include N-(1,3-dimethylbutyl)-N′-phenyl-p-phenylenediamine and polymerized 2,2,4-trimethyl-1,2-dihydroquinoline. Thereamong, zinc white, stearic acid, zinc stearate, or N-(1,3-dimethylbutyl)-N′-phenyl-p-phenylenediamine can be used as the crosslinking agent for the dynamic crosslinking.

The amount of the crosslinking agent is preferably 4 to 12 parts by weight, more preferably 6 to 9 parts by weight, based on 100 parts by weight of the brominated isobutylene-p-methylstyrene copolymer. An excessively small amount of the crosslinking agent leads to insufficient dynamic crosslinking; therefore, the brominated isobutylene-p-methylstyrene copolymer cannot be maintained in a finely dispersed state, and the durability is reduced. Meanwhile, an excessively large amount of the crosslinking agent causes scorching during kneading or processing, and generation of a foreign matter in a film.

The acid-modified styrene-ethylene-butylene-styrene copolymer (C) used in the present invention is obtained by modifying a styrene-ethylene-butylene-styrene copolymer (hereinafter, also referred to as “SEBS”) with an acid, and examples thereof include maleic anhydride-modified styrene-ethylene-butylene-styrene copolymers and carboxyl-modified styrene-ethylene-butylene-styrene copolymers. Examples of commercially available acid-modified styrene-ethylene-butylene-styrene copolymer products include KRATON® FG1924 manufactured by Kraton Corporation, TUFTEC® M1913 and M1943 manufactured by Asahi Kasei Chemicals Corporation, and f-DYNARON® F8660P manufactured by JSR Corporation.

The styrene content S_{C} in the acid-modified styrene-ethylene-butylene-styrene copolymer (C) is not particularly limited as long as the above-described relational formula is satisfied; however, it is preferably 5 to 40% by weight, more preferably 8 to 36% by weight, still more preferably 10 to 32% by weight. When the styrene content S_{C} is excessively low, the effect of suppressing a change in the gas-barrier properties caused by fatigue may be insufficient, whereas when the styrene content S_{C} is excessively high, the acid-modified styrene-ethylene-butylene-styrene copolymer (C) is not finely dispersed in the ethylene-vinyl alcohol copolymer, and its modification effect as an elastomer may thus be insufficient.

The acid value of the acid-modified styrene-ethylene-butylene-styrene copolymer (C) is preferably, but not limited to, 0.5 to 30 mg-CH₃ONa/g, more preferably 1.0 to 25 mg-CH₃ONa/g, still more preferably 1.5 to 20 mg-CH₃ONa/g. When the acid value is excessively low, the acid-modified styrene-ethylene-butylene-styrene copolymer (C) is not finely dispersed in the ethylene-vinyl alcohol copolymer, and its modification effect as an elastomer may thus be insufficient, whereas when the acid value is excessively high, the fluidity is reduced due to enhanced interaction with the vinyl alcohol of the ethylene-vinyl alcohol copolymer, and this may lead to deterioration of the film-forming properties.

As for the acid value of the acid-modified styrene-ethylene-butylene-styrene copolymer (C), 1 g of the acid-modified styrene-ethylene-butylene-styrene copolymer is neutralization-titrated with sodium methoxide (CH₃ONa), and the mass (mg) of sodium methoxide (CH₃ONa) used can be determined as the acid value.

The weight ratio (B)/(C) of the brominated isobutylene-p-methylstyrene copolymer (B) to the acid-modified styrene-ethylene-butylene-styrene copolymer (C) is preferably 60/40 to 10/90, more preferably 55/45 to 20/85, still more preferably 50/50 to 30/70. An excessively low weight ratio (B)/(C) may lead to insufficient pre-fatigue gas-barrier properties, whereas an excessively high weight ratio (B)/(C) may lead to insufficient durability at low temperatures.

The amount of the ethylene-vinyl alcohol copolymer (A) to be incorporated is preferably 20 to 300 parts by weight, more preferably 30 to 250 parts by weight, still more preferably 40 to 220 parts by weight, based on 100 parts by weight of the elastomer components in the dispersed phase. When the ethylene-vinyl alcohol copolymer (A) is incorporated in an excessively small amount, the gas-barrier properties may be insufficient, whereas when the ethylene-vinyl alcohol copolymer (A) is incorporated in an excessively large amount, the durability at low temperatures and the flexibility may be insufficient.

The term “elastomer components in the dispersed phase” used herein refers to at least the brominated isobutylene-p-methylstyrene copolymer (B) and the acid-modified styrene-ethylene-butylene-styrene copolymer (C) and, when other elastomer(s) (e.g., a halogenated butyl rubber, an ethylene-propylene rubber, and an acid-modified EB) is/are contained in the dispersed phase, the term also encompasses such elastomer(s). In other words, when the dispersed phase comprises only two kinds of elastomers which are the brominated isobutylene-p-methylstyrene copolymer (B) and the acid-modified styrene-ethylene-butylene-styrene copolymer (C), the amount of the incorporated ethylene-vinyl alcohol copolymer (A) is calculated based on 100 parts by weight of the total weight of the brominated isobutylene-p-methylstyrene copolymer (B) and the acid-modified styrene-ethylene-butylene-styrene copolymer (C). When the dispersed phase comprises other elastomer(s) in addition to the brominated isobutylene-p-methylstyrene copolymer (B) and the acid-modified styrene-ethylene-butylene-styrene copolymer (C), the amount of the incorporated ethylene-vinyl alcohol copolymer (A) is calculated based on 100 parts by weight of the total weight of the brominated isobutylene-p-methylstyrene copolymer (B), the acid-modified styrene-ethylene-butylene-styrene copolymer (C), and the other elastomer(s).

It is preferable that the thermoplastic resin composition of the present invention further comprises a metallic soap (D). Examples of the metallic soap (D) include an alkaline earth metal salt of a higher fatty acid. Specific examples of an alkaline earth metal salt of a higher fatty acid include magnesium stearate, calcium stearate, barium stearate, magnesium laurate, calcium laurate and barium laurate, among which magnesium stearate is preferable. The amount of the metallic soap (D) to be incorporated is preferably, but not limited to, 0 to 20 parts by weight, more preferably 0.5 to 15 parts by weight, still more preferably 1.0 to 10 parts by weight, based on 100 parts by weight of the elastomer components. By incorporating the metallic soap (D), the lubricity is improved and the extrusion load during melt-molding is reduced, so that the generation of residues is suppressed. When the metallic soap (D) is incorporated in an excessively large amount, the durability at low temperatures may be deteriorated.

The thermoplastic resin composition of the present invention may also comprise a resin other than the ethylene-vinyl alcohol copolymer (A), an elastomer other than the brominated isobutylene-p-methylstyrene copolymer (B) and the acid-modified styrene-ethylene-butylene-styrene copolymer (C), and various additives within a range that does not adversely affect the effects of the present invention. Examples of the additives include a crosslinking agent, an age inhibitor, a plasticizer, a processing aid, a crosslinking accelerator aid, a crosslinking accelerator, a reinforcing agent (a filler), an antiscorching agent, a peptizing agent, an organic modifier, a softening agent, and a tackifier.

The thermoplastic resin composition of the present invention can be produced by, but not limited to, melt-kneading an ethylene-vinyl alcohol copolymer, a brominated isobutylene-p-methylstyrene copolymer, an acid-modified styrene-ethylene-butylene-styrene copolymer and, as required, a metallic soap and other component(s). When the crosslinking agent is added, the crosslinking agent may be mixed with the brominated isobutylene-p-methylstyrene copolymer in advance, or it may be added before or during the melt-kneading. The melt-kneading temperature is a temperature of not lower than the melting point of a polymer having the highest melting point among the polymer components constituting the thermoplastic resin composition, and it is preferably 20° C. higher than this melting point, for example, 160 to 280° C. The melt-kneading time is usually 1 to 10 minutes, preferably 1 to 5 minutes.

The thermoplastic resin composition of the present invention can be preferably produced by continuously kneading an ethylene-vinyl alcohol copolymer, a brominated isobutylene-p-methylstyrene copolymer and an acid-modified styrene-ethylene-butylene-styrene copolymer using a biaxial kneader and thereby not only dispersing the brominated isobutylene-p-methylstyrene copolymer and the acid-modified styrene-ethylene-butylene-styrene copolymer in a matrix phase composed of the ethylene-vinyl alcohol copolymer but also performing dynamic crosslinking.

More specifically, for example, a rubber compound is prepared by mixing a brominated isobutylene-p-methylstyrene copolymer, an acid-modified styrene-ethylene-butylene-styrene copolymer, a crosslinking agent and, as required, other additive(s) at 60 to 150° C., the thus obtained rubber compound, an ethylene-vinyl alcohol copolymer and, as required, other resin(s) or additive(s) are loaded to a biaxial kneader having a preset temperature of 220 to 250° C., and then the brominated isobutylene-p-methylstyrene copolymer and the acid-modified styrene-ethylene-butylene-styrene copolymer are dispersed and dynamically crosslinked, whereby the thermoplastic resin composition of the present invention can be obtained.

The present invention also provides an inner liner for a pneumatic tire, which comprises the above-described thermoplastic resin composition.

The thermoplastic resin composition of the present invention can be made into a film using, for example, an extruder equipped with a T-die or an inflation molding machine. The film composed of the thermoplastic resin composition of the present invention has excellent gas-barrier properties and durability and, therefore, can be suitably used as an inner liner of a pneumatic tire.

The present invention also provides a pneumatic tire comprising the above-described inner liner.

The pneumatic tire of the present invention is more specifically a pneumatic tire comprising a film of the above-described thermoplastic resin composition as an inner liner. As a method of producing the pneumatic tire, any commonly-used method can be employed. For example, the thermoplastic resin composition of the present invention is extruded into the form of a film having a prescribed width and a prescribed thickness, and this film is attached onto a tire molding drum in a cylindrical form as an inner liner. Subsequently, members that are used in ordinary tire production, such as a carcass layer, a belt layer and a tread layer that are composed of unvulcanized rubber, are sequentially laminated on the inner liner, and the resultant is pulled out from the drum to obtain a green tire. Thereafter, this green tire is heat-vulcanized in accordance with a conventional method, whereby a desired pneumatic tire can be produced.

### EXAMPLES

The present invention will now be described in more detail by way of Examples thereof; however, the present invention is not limited to the below-described Examples.

### [Raw Materials]

The raw materials used in the below-described Examples and Comparative Examples are as follows.

The following three products were used as an ethylene-vinyl alcohol copolymer (hereinafter, also referred to as “EVOH”).

SOARNOL® V2504, manufactured by The Nippon Synthetic Chemical Industry Co., Ltd., and having a vinyl alcohol content V_{A} of 83% by weight

SOARNOL® E3808, manufactured by The Nippon Synthetic Chemical Industry Co., Ltd., and a vinyl alcohol content V_{A} of 72% by weight

SOARNOL® 114815B, manufactured by The Nippon Synthetic Chemical Industry Co., Ltd., and having a vinyl alcohol content V_{A} of 63% by weight

The following three products were used as a brominated isobutylene-p-methylstyrene copolymer (hereinafter, also referred to as “Br-IPMS”).

EXXPRO® 3745: a brominated isobutylene-p-methylstyrene copolymer rubber, manufactured by ExxonMobil Chemical Company, Inc., and having a p-bromomethylstyrene content B_{B} of 3.9% by weight

EXXPRO® MDX89-4: a brominated isobutylene-p-methylstyrene copolymer rubber, manufactured by ExxonMobil Chemical Company, Inc., and having a p-bromomethylstyrene content B_{B} of 2.5% by weight

EXXPRO® 3035: a brominated isobutylene-p-methylstyrene copolymer rubber, manufactured by ExxonMobil Chemical Company, Inc., and having a p-bromomethylstyrene content B_{B} of 1.6% by weight

The following was used as other brominated rubber.

Br-IIR: a brominated butyl rubber BROMO BUTYL, manufactured by ExxonMobil Chemical Company, Inc., and having a p-bromomethylstyrene content B_{B} of 0% by weight

The following four products were used as an acid-modified styrene-ethylene-butylene-styrene copolymer.

KRATON® FG1924: a maleic anhydride-modified styrene-ethylene-butylene-styrene copolymer, manufactured by Kraton Corporation, and a styrene content S_{C} of 13% by weight

TUFTEC® M1943: a maleic anhydride-modified styrene-ethylene-butylene-styrene copolymer, manufactured by Asahi Kasei Chemicals Corporation, and having a styrene content S_{C} of 20% by weight

f-DYNARON 8660P: a maleic anhydride-modified styrene-ethylene-butylene-styrene copolymer, manufactured by JSR Corporation, and having a styrene content S_{C} of 25% by weight

TUFTEC® M1913: a maleic anhydride-modified styrene-ethylene-butylene-styrene copolymer, manufactured by Asahi Kasei Chemicals Corporation, and having a styrene content S_{C} of 30% by weight

The following was used as other acid-modified rubber.

Acid-modified EB: a maleic anhydride-modified ethylene-1-butene, TAFMER® MH7010, manufactured by Mitsui Chemicals, Inc., and having a styrene content S_{C} of 0% by weight

The following was used as other polymer component.

Nylon 6: UBE NYLON 1030B, manufactured by UBE Industries, Ltd.

The following was used as a metallic soap.

St-Mg: magnesium stearate, SM-PG, manufactured by Sakai Chemical Industry Co., Ltd.

### [Preparation of Thermoplastic Resin Compositions]

In accordance with the respective formulations shown in Tables 1 and 2, an ethylene-vinyl alcohol copolymer (A), a brominated isobutylene-p-methylstyrene copolymer (B), an acid-modified styrene-ethylene-butylene copolymer (C) and other components were introduced to a cylinder of a biaxial kneading extruder manufactured by The Japan Steel Works, Ltd. and then transferred to a kneading zone where the temperature was set at 230° C. and the retention time was set at about 3 to 8 minutes, and these materials were melt-kneaded, after which the resulting melt-kneaded product was extruded in the shape of a strand from a die attached to a discharge port. The thus obtained strand-shaped extrudate was pelletized using a resin pelletizer to obtain a pellet-shaped thermoplastic resin composition. For this thermoplastic resin composition, the rate of change in the air permeability coefficient due to fatigue was evaluated. The evaluation results are shown in Tables 1 and 2.

### [Rate of Change in Air Permeability Coefficient Due to Fatigue]

Each pellet-shaped thermoplastic resin composition prepared above was molded into a film of 0.1 mm in average thickness using a 40-mmϕ uniaxial extruder equipped with a 550 mm-wide T-die manufactured by Pla Giken Co., Ltd. under the extrusion conditions having extrusion temperatures in C1/C2/C3/C4/die of 220/225/230/235/235° C., a cooling roll temperature of 50° C., and a drawing rate of 4 m/min. The thus obtained film was cut out at a prescribed size and laminated with a sheet having an average thickness of 0.1 mm of an unvulcanized rubber composition having the formulation shown in Table 3, and the film and the sheet were subsequently adhered by vulcanizing at 180° C. for 10 minutes, whereby a laminate of the thermoplastic resin composition and the rubber composition was obtained. This laminate was cut out at a width of 5 cm and repeatedly deformed 1,000,000 times using a constant strain tester manufactured by Ueshima Seisakusho Co., Ltd. The air permeability coefficient of the laminate was measured at a temperature of 23° C. and a humidity of 0% RH before and after the repeated deformation, and the rate of change in the air permeability coefficient due to fatigue was calculated using the following equation:

Rate of change in air permeability coefficient due to fatigue=Air permeability coefficient after deformation/Air permeability coefficient before deformation.

The laminate was evaluated to be satisfactory i.e., have a suppression effect, when the rate of change in the air permeability coefficient due to fatigue was 2.0 or lower.

TABLE 1

| | | | | Comparative | Example | Example | Example | Example | Example | Example |
|---|---|---|---|---|---|---|---|---|---|---|
| | | | | Example 1 | 1 | 2 | 3 | 4 | 5 | 6 |
| EVOH resin | SOARNOL ® | V_{A} (% by | parts by | | | | | | | |
| | V2504 | weight) = 83 | weight | | | | | | | |
| | SOARNOL ® | V_{A} (% by | parts by | 50 | 50 | 40 | | | | |
| | E3808 | weight) = 72 | weight | | | | | | | |
| | SOARNOL ® | V_{A} (% by | parts by | | | | 40 | 40 | 40 | 40 |
| | H4815B | weight) = 63 | weight | | | | | | | |
| Br-IPMS | EXXPRO ® | B_{B} (% by | parts by | | | | | | | |
| | 3745 | weight) = 3.9 | weight | | | | | | | |
| | EXXPRO ® | B_{B} (% by | parts by | 30 | 30 | 40 | 40 | 40 | 45 | 45 |
| | MDX89-4 | weight) = 2.5 | weight | | | | | | | |
| | EXXPRO ® | B_{B} (% by | parts by | | | | | | | |
| | 3035 | weight) = 1.6 | weight | | | | | | | |
| Br-IIR | BROMO | B_{B} (% by | parts by | | | | | | | |
| | BUTYL | weight) = 0 | weight | | | | | | | |
| Acid-modified | KRATON ® | S_{C} (% by | parts by | | 70 | | | | | |
| SEBS | FG1924 | weight) = 13 | weight | | | | | | | |
| | TUFTEC ® | S_{C} (% by | parts by | | | 60 | | | | |
| | M1943 | weight) = 20 | weight | | | | | | | |
| | f-DYNARON ® | S_{C} (% by | parts by | | | | 60 | | | |
| | 8660P | weight) = 25 | weight | | | | | | | |
| | TUFTEC ® | S_{C} (% by | parts by | | | | | 60 | 55 | 55 |
| | M1913 | weight) = 30 | weight | | | | | | | |
| Acid-modified EB | TAFMER ® | S_{C} (% by | parts by | 70 | | | | | | |
| | MH7010 | weight) = 0 | weight | | | | | | | |
| Other polymer | UBE NYLON | | parts by | | | | | | | |
| component | 1030B | | weight | | | | | | | |
| Metallic soap | St-Mg | | parts by | 2 | 2 | 2 | 2 | 2 | 2 | |
| | | | weight | | | | | | | |

| | | | | | | | |
|---|---|---|---|---|---|---|---|
| W_{A} | 0.33 | 0.33 | 0.29 | 0.29 | 0.29 | 0.29 | 0.29 |
| W_{B} | 0.20 | 0.20 | 0.29 | 0.29 | 0.29 | 0.32 | 0.32 |
| W_{C} | 0.47 | 0.47 | 0.43 | 0.43 | 0.43 | 0.39 | 0.39 |
| (W_{A} × B_{B}) × (W_{C} × S_{C})/(W_{A} × V_{A}) | 0.0 | 0.13 | 0.30 | 0.37 | 0.45 | 0.53 | 0.53 |
| Rate of change in air permeability coefficient due to fatigue | 2.5 | 1.6 | 1.4 | 1.3 | 1.2 | 1.4 | 1.5 |

TABLE 2

| | | | | Comparative | Comparative | Example | Example | Comparative | Example | Example |
|---|---|---|---|---|---|---|---|---|---|---|
| | | | | Example 2 | Example 3 | 7 | 8 | Example 4 | 9 | 10 |
| EVOH | SOARNOL ® | V_{A} (% by | parts by | | 200 | 100 | | | | |
| resin | V2504 | weight) = 83 | weight | | | | | | | |
| | SOARNOL ® | V_{A} (% by | parts by | 50 | | | | | 50 | 50 |
| | E3808 | weight) = 72 | weight | | | | | | | |
| | SOARNOL ® | V_{A} (% by | parts by | | | | 40 | 30 | | |
| | H4815B | weight) = 63 | weight | | | | | | | |
| Br-IPMS | EXXPRO ® | B_{B} (% by | parts by | | | | 40 | 30 | | |
| | 3745 | weight) = 3.9 | weight | | | | | | | |
| | EXXPRO ® | B_{B} (% by | parts by | | | | | | 40 | 50 |
| | MDX89-4 | weight) = 2.5 | weight | | | | | | | |
| | EXXPRO ® | B_{B} (% by | parts by | | 60 | 50 | | | | |
| | 3035 | weight) = 1.6 | weight | | | | | | | |
| Br-IIR | BROMO | B_{B} (% by | parts by | 30 | | | | | | |
| | BUTYL | weight) = 0 | weight | | | | | | | |
| Acid- | KRATON ® | S_{C} (% by | parts by | | 40 | 50 | | | | |
| modified | FG1924 | weight) = 13 | weight | | | | | | | |
| SEBS | TUFTEC ® | S_{C} (% by | parts by | | | | | | 60 | 40 |
| | M1943 | weight) = 20 | weight | | | | | | | |
| | f-DYNARON ® | S_{C} (% by | parts by | | | | | | | |
| | 8660P | weight) = 25 | weight | | | | | | | |
| | TUFTEC ® | S_{C} (% by | parts by | 70 | | | 60 | 70 | | |
| | M1913 | weight) = 30 | weight | | | | | | | |
| Acid- | TAFMER ® | S_{C} (% by | parts by | | | | | | | 20 |
| modified | MH7010 | weight) = 0 | weight | | | | | | | |
| EB | | | | | | | | | | |
| Other | UBE NYLON | | parts by | | | | | 10 | 20 | |
| polymer | 1030B | | weight | | | | | | | |
| component | | | | | | | | | | |
| Metallic | St-Mg | | parts by | 2 | 2 | 2 | 2 | 2 | 2 | 2 |
| soap | | | weight | | | | | | | |

| | | | | | | | |
|---|---|---|---|---|---|---|---|
| W_{A} | 0.33 | 0.67 | 0.50 | 0.29 | 0.21 | 0.29 | 0.31 |
| W_{B} | 0.20 | 0.20 | 0.25 | 0.29 | 0.21 | 0.24 | 0.31 |
| W_{C} | 0.47 | 0.13 | 0.25 | 0.43 | 0.50 | 0.35 | 0.38 |
| (W_{A} × B_{B}) × (W_{C} × S_{C})/(W_{A} × V_{A}) | 0.0 | 0.01 | 0.03 | 0.80 | 0.93 | 0.20 | 0.26 |
| Rate of change in air permeability | 2.4 | 2.3 | 1.9 | 1.6 | film could | 1.5 | 1.5 |
| coefficient due to fatigue | | | | | not be | | |
| | | | | | formed | | |

TABLE 3
Formulation of Unvulcanized Rubber Composition

| Raw materials | Amount (parts by weight) |
|---|---|
| Halogenated butyl rubber⁽¹⁾ | 100 |
| GPF carbon black⁽²⁾ | 30 |
| Wet silica⁽³⁾ | 20 |
| Aromatic oil⁽⁴⁾ | 7.5 |
| Zinc white⁽⁵⁾ | 3 |
| Stearic acid⁽⁶⁾ | 1 |
| Sulfur⁽⁷⁾ | 1 |
| Vulcanization accelerator⁽⁸⁾ | 1.5 |
| Total | 164 |

Footnote:
⁽¹⁾BROMOBUTYL X2, manufactured by LANXESS Rubber Corporation
⁽²⁾HTC #G, manufactured by NSCC Carbon Co., Ltd.
⁽³⁾ZEOSIL ® 165GR, manufactured by Rhodia Corporation
⁽⁴⁾EXTRACT 4S, manufactured by Showa Shell Sekiyu K.K.
⁽⁵⁾zinc oxide #3, manufactured by Seido Chemical Industry Co., Ltd.
⁽⁶⁾beads stearic acid YR, manufactured by NOF Corporation
⁽⁷⁾“GOLDEN FLOWER” SULFUR POWDER, 150 mesh, manufactured by Tsurumi Chemical Industry Co., Ltd.
⁽⁸⁾NOCCELER DM, manufactured by Ouchi Shinko Chemical Industrial Co., Ltd.

### INDUSTRIAL APPLICABILITY

The thermoplastic resin composition of the present invention can be suitably utilized for the production of an inner liner for pneumatic tires.

1. A thermoplastic resin composition comprising
a matrix phase that comprises an ethylene-vinyl alcohol copolymer (A), and
a dispersed phase that comprises a brominated isobutylene-p-methylstyrene copolymer (B) and an acid-modified styrene-ethylene-butylene-styrene copolymer (C),
wherein the thermoplastic resin composition satisfies the following formula:
0.02≤(W_{B}×B_{B})×(W_{C}×S_{C})/(W_{A}×V_{A})≤0.85
wherein
W_{A} represents a weight ratio of the ethylene-vinyl alcohol copolymer (A) to a total weight of polymer components in the thermoplastic resin composition,
W_{B} represents a weight ratio of the brominated isobutylene-p-methylstyrene copolymer (B) to a total weight of polymer components in the thermoplastic resin composition,
W_{C} represents a weight ratio of the acid-modified styrene-ethylene-butylene-styrene copolymer (C) to a total weight of polymer components in the thermoplastic resin composition,
V_{A} represents a vinyl alcohol content (% by weight) in the ethylene-vinyl alcohol copolymer (A),
B_{B} represents a p-bromomethylstyrene content (% by weight) in the brominated isobutylene-p-methylstyrene copolymer (B), and
S_{C} represents a styrene content (% by weight) in the acid-modified styrene-ethylene-butylene-styrene copolymer (C).

2. The thermoplastic resin composition according to claim 1, wherein the acid-modified styrene-ethylene-butylene-styrene copolymer (C) has an acid value of 0.5 to 30 mg-CH₃ONa/g.

3. The thermoplastic resin composition according to claim 1, wherein a weight ratio (B)/(C) of the brominated isobutylene-p-methylstyrene copolymer (B) and the acid-modified styrene-ethylene-butylene-styrene copolymer (C) is 60/40 to 10/90.

4. The thermoplastic resin composition according to claim 1, comprising 20 to 300 parts by weight of the ethylene-vinyl alcohol copolymer (A) based on 100 parts by weight of elastomer components in the dispersed phase.

5. The thermoplastic resin composition according to claim 1, wherein the vinyl alcohol content V_{A} (% by weight) in the ethylene-vinyl alcohol copolymer (A) is 50 to 90.

6. The thermoplastic resin composition according to claim 1, wherein the p-bromomethylstyrene content B_{B} (% by weight) in the brominated isobutylene-p-methylstyrene copolymer (B) is 1.0 to 5.0.

7. The thermoplastic resin composition according to claim 1, wherein the styrene content S_{C} (% by weight) in the acid-modified styrene-ethylene-butylene-styrene copolymer (C) is 5 to 40.

8. The thermoplastic resin composition according to claim 1, further comprising a metallic soap (D).

9. An inner liner for a pneumatic tire, comprising the thermoplastic resin composition according to claim 1.

10. A pneumatic tire comprising the inner liner according to claim 9.

11. The thermoplastic resin composition according to claim 2, wherein a weight ratio (B)/(C) of the brominated isobutylene-p-methylstyrene copolymer (B) and the acid-modified styrene-ethylene-butylene-styrene copolymer (C) is 60/40 to 10/90.

12. The thermoplastic resin composition according to claim 2, comprising 20 to 300 parts by weight of the ethylene-vinyl alcohol copolymer (A) based on 100 parts by weight of elastomer components in the dispersed phase.

13. The thermoplastic resin composition according to claim 3, comprising 20 to 300 parts by weight of the ethylene-vinyl alcohol copolymer (A) based on 100 parts by weight of elastomer components in the dispersed phase.

14. The thermoplastic resin composition according to claim 2, wherein the vinyl alcohol content V_{A} (% by weight) in the ethylene-vinyl alcohol copolymer (A) is 50 to 90.

15. The thermoplastic resin composition according to claim 3, wherein the vinyl alcohol content V_{A} (% by weight) in the ethylene-vinyl alcohol copolymer (A) is 50 to 90.

16. The thermoplastic resin composition according to claim 4, wherein the vinyl alcohol content V_{A} (% by weight) in the ethylene-vinyl alcohol copolymer (A) is 50 to 90.

17. The thermoplastic resin composition according to claim 2, wherein the p-bromomethylstyrene content B_{B} (% by weight) in the brominated isobutylene-p-methylstyrene copolymer (B) is 1.0 to 5.0.

18. The thermoplastic resin composition according to claim 3, wherein the p-bromomethylstyrene content B_{B} (% by weight) in the brominated isobutylene-p-methylstyrene copolymer (B) is 1.0 to 5.0.

19. The thermoplastic resin composition according to claim 4, wherein the p-bromomethylstyrene content B_{B} (% by weight) in the brominated isobutylene-p-methylstyrene copolymer (B) is 1.0 to 5.0.

20. The thermoplastic resin composition according to claim 5, wherein the p-bromomethylstyrene content B_{B} (% by weight) in the brominated isobutylene-p-methylstyrene copolymer (B) is 1.0 to 5.0.
